(19) United States
(12) Patent Application Publication
(10) Pub. No.: US 2008/0050707 A1
(43) Pub. Date: Feb. 28, 2008

(54) Psychological transition bag and journal self-help system

(76) Inventor: Jenifer A. Girouard, South Paris, ME (US)

Correspondence Address: Donald W. Meeker;Patent Agent, 924 East Ocean Front #E, Newport Beach, CA, 92661, US

(21) Appl. No.: 11/502,555

(22) Filed: Aug. 11, 2006

(51) Int. Cl. G09B 19/00

(52) U.S. Cl. 434/236

(57) ABSTRACT

A personalized psychological transition guidance system to assist a child through the difficulties of divorce or separation comprising a combination of a transitional journal and a transition bag for photos and memorabilia. The carrying bag has removable picture frames on both sides of the bag for pictures representing each side of the broken family. The bag is washable with the photo frames removed. The transitional journal has frames on both covers for pictures, one on each side. The journal has a front and a rear section of pages, one section for each side of the broken family. Each of the sections of pages includes a contact page, calendar, holiday schedule, journal pages for the parents to write on, psychologically instructive information on what needs to be communicated, and parenting ground rules.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to education and guidance related to subject matter relating to the behavioral characteristics of an individual or group focused on child psychology and particularly to a self-help guidance system for a child going through a psychological transition in a family divorce or separation, the system comprising a personal combination transition guide book journal and transition bag for helping a child cope with the separation and divorce of his or her parents, and a washable transition journal carrying bag having detachable decorative photo sleeves on the front and back thereof for dual memorable photos for the child, a photo on one side of the bag related to one side of the broken family and another photo on the opposite side of the bag related to the other side of the broken family; the journal comprises a dual sided loose-leaf binder having a front memorable photo related to one side of the broken family followed by a contact sheet, calendar, holiday list, journal pages for the child to write on, photo sleeves for including photographs from both sides of the family, a contact information sheet for both sides of the family, a yearly calendar overview, a yearly holiday schedule, information on what needs to be communicated and parenting ground rules.

2. Description of Related Art Including Information Disclosed Under 37 CFR 1.97 and 1.98

The separation and subsequent divorce of parents is a highly stressful time in a child's life. Many parents, although they cannot save their marriage, both want the transition to be as smooth as possible for the child, so that the child remains well-adjusted throughout the divorce. In the past tools such as cards, dolls and puppets have been used to help the child communicate their feelings about separation and divorce.

None of the prior art systems provide for a collection of actual photos of events including the child and the members of each side of the broken family symbolically compiled together in one personalized volume, which also includes blank journal pages, and printed pages with guidance for parents and the child in helping the child through the difficult time and the prior art also fails to provide a carrying bag for the volume with space for other personalized memorabilia gathered together in one location with the personalized photo, journal, and guidance information book.

Prior art U.S. Patent Application #20040133440, published Jul. 8, 2004 by Carolan, is for a computer-based interactive system that provides tools for divorced parents to manage their parenting responsibilities such as custody arrangements, visitation, child support, and shared medical expenses. With the system of the invention, parents can share information about schedules, documents, activities and bills via their own secure, personalized website. The invention also facilitates the assistance to them by attorneys, counselors, and employers. The invention addresses the needs of all those associated with parenting and divorce and may be available to users according to various service levels.

Prior art U.S. Patent Application #20040172279, published Sep. 2, 2004 by Carolan, provides a method, system, and computer-readable signal containing instructions for facilitating complex relationship-based interactions among users of a community, such community corresponding to a broken family. A database is communicably coupled to a full-time, public network, wherein the database includes functionalities and is configured to make said functionalities accessible via the full-time, public network. Data is recorded in the database defining the community and associating a manager with the community, wherein the manager is a user of the community. The manager can invite others to join the community in order to become additional users of the community. The manager can establish common approval items with regard to which two specific users must agree in order to make a decision. One or more users of the community can share information with one or more other users of the community.

Prior art U.S. Pat. No. 6,854,915, issued Feb. 15, 2005 to Ong, is for a binder for papers, photographs, or other sheet-like materials which has a cover having one or more window openings defined therein. A flat, transparent protective sheet is located in contact with the inside surface of the binder cover and a backing sheet overlies the protective sheet. The backing sheet is secured to the peripheral margin of the protective sheet, and elsewhere as required, to delineate at least one, and preferably a plurality of pockets. The pockets are formed between the backing sheet and the protective sheet. An elongated slit in defined through the backing sheet behind each pocket created. The peripheral edges of the backing sheet are permanently secured to the inside surface of the binder cover. Photographs or other flat display materials may be inserted into the pockets formed between the backing sheet and the protective sheet through the elongated slits. The pockets are delineated so that they are aligned with the window opening in the cover. The photographs or other display materials may thereby be viewed through the window openings from the outside through the transparent protective sheet. Selected display materials may be inserted and withdrawn from the pockets through the elongated slits in the backing cover.

Two prior art U.S. Pat. No. 5,857,797 issued Jan. 12, 1999 and U.S. Pat. No. 6,368,005 issued Apr. 9, 2002 to Streff, provide a loose leaf binder including an exterior picture frame. The three-ring binder includes a spine, front cover and back cover, each of which includes a substantially solid base plate and an outer plastic shell. The spine and front cover each includes a rectangular picture frame, the outer edges of which are aligned with and welded to the bottom and side edges of the spine and cover. A clear plastic membrane is secured to the frame's interior covering the opening in the picture frame. The frame top edges are spaced inwardly and free of the shell to form insert pockets. Display inserts are slidably mounted within the insert pockets defined by the frames. The spine insert includes an upper folded edge. An L-shaped member extends through an opening in the folded edge, and includes an outer pin head. Pulling upwardly on the pin head withdraws the insert. Mount mats of a semi-solid paper are provided in the pockets to receive thin, flexible paper for insertion into the frame pockets. The inserted mat holds the display material with the insert pocket.

Prior art U.S. Pat. No. 5,411,293, issued May 2, 1995 to Monzyk, claims a double cover ring binder including a first cover and a second cover interconnected by a ring element. The first cover is divided into mirror image sections each having a pocket on at least one face. The second cover is also divided into mirror-image sections each having a pocket on at least one face.

Prior art U.S. Pat. No. 4,164,085, issued Aug. 14, 1979 to Steeb, describes a keepsake album that has a frame assembly imbedded in its padded front cover for displaying a personalizing photograph in recessed relation to the outer-surface of the cover. A photograph-receiving tray which forms a part of the frame assembly is disposed within a complementally configured blind opening in the cover and is solidly undersupported by the exposed rigid backing member of the cover along the bottom of the blind opening. The tray is adapted to releasably retain a decorative frame in abutment with the outer surface of the cover for holding the desired photograph in a displayed position on the cover.

Prior art U.S. Pat. No. 6,899,541, issued May 31, 2005 to Kassai, discloses a life log or journal which is directed to produce a record of the life of a child by parent and child, explicitly divided into a fetus era, newborn era, school era, grown-up era, and mature-age era, guiding a parent to write down a record when the child is too young to write for himself/herself, and guiding the child to write for himself/herself when the child grows up. In the region guiding the parent to write down a record, an instruction is printed to inspire the parent to facilitate writing down events of the child's development on occasion together with the parent's feelings at that time. As a result, a life log can be produced, leaving the affection devoted from the parent to child in a visual form so that the parent and child can share affection, joy and emotions throughout the childhood and adulthood of the child.

Prior art U.S. Pat. No. 4,341,521, issued Jul. 27, 1982 to Solomon, concerns a psychotherapeutic device for use by a therapist with a non-verbal or resistant child subject, wherein the child is shown a page of a book depicting a dramatic if not traumatic scene relevant to the child's life, such as the divorce of his parents. A series of puppets depicting a character of like gender to the subject child, is provided juxtaposed to the page, and wherein each of the puppets displays a different emotion. The child reads or is read a story related to the scene and asked to place or affix the character puppet into the scene, which puppet exhibits the emotion that the child believes the character is feeling.

Prior art U.S. Pat. No. 4,924,613, issued May 15, 1990 to Levin, provides a garment with replaceable displays. A garment having a flat panel is provided with a clear, flexible plastic sheet window. One member of a hook-and-loop fastener is affixed to the perimeter of the window. The second member of the hook-and-loop fastener is affixed to the flat panel of the garment in a pattern matching that of the first member on the window. Any sheet or card bearing indicia may be removably displayed on the garment by simply laying it on the garment within the space enclosed by the second member of the fastener and covering it with the window which removably seals it in place when the two members of the hook-and-loop fastener are pressed together. To change indicia, one pulls the window off the garment, replaces the indicia bearing sheet, and presses the window back in place. The invention may be supplied in kit form for application to a garment of the user's choice.

Prior art U.S. Pat. No. 2,986,743, issued Jun. 6, 1961 to Eilen, relates an auxiliary pocket for garments which may hold nameplates, photographs, and the like for permitting external viewing through a transparent window.

What is needed is a combination of a bag carrying case for memorabilia including the child with both sides of the broken family and with removable picture frames on both sides of the bag so that it is washable and a binder journal with photos of the child with members of both sides of the broken family, pages to write on, and instructional pages for parents and children in families experiencing divorce or separation.

### BRIEF SUMMARY OF THE INVENTION

An object of the present invention is to provide a total personalized self-help transition guidance system to assist a child through the difficult time of divorce or separation comprising a combination of a bag carrying case for memorabilia including photos of the child with each of the sides of the broken family and with removable picture frames on both sides of the bag of the child with members of both sides of the broken family, one on each side, so that the bag is washable with the photo frames removed; and a binder journal with a front cover and front section of pages with a front cover photo and a back cover photo and sections of pages including a contact page, calendar, and holiday schedule, journal pages to write on, and psychologically instructive information on what needs to be communicated and parenting notebook ground rules for the parents of the child.

Another object of the present invention is to provide a child with much needed structure during the transition of divorce or separation by providing a journal with a calendar, and holiday schedule, and psychologically instructive information on what needs to be communicated and parenting notebook ground rules, thereby providing common guidelines for the separated parents.

In brief, the present invention comprises a child's divorce or separation transition system. The system comprises a transition journal and a carrying bag for the journal. The transitional journal is preferably a 3-ring journal and guidance book with picture holders on the front and back covers in which memorable photos of each side of the broken family may be placed. The journal further comprises a front and a rear section of pages, one section for each side of the broken family. Each of the sections of pages includes a contact information sheet, calendar, holiday schedule, journal pages, psychologically instructive information on what needs to be communicated and parenting notebook ground rules for the parents, preferably both from the book, “Co-Parenting Survival Guide”. The transitional bag and journal provide a personalized way for a child to work through the difficult time of divorce or separation in a family and to compile photos and other memorabilia in the transition bag all together in one place to help the child work through the difficulties.

The transition bag has two removable family photo frames, one on each side of the transition bag. The child may choose memorable photos from each side of the broken family to place in the family photo frames. The frames are removably attached so that the bag may be washed without damaging the photographs held within the frames. The easy snap on/off photo pockets come in a choice of colors. Decorative beads reading words, such as “LOVE” and “FAMILY”, may hang above each photo on the photo pockets to help comfort the child. The canvas bag (preferably red in color) is machine washable with the photo pockets removed.

The primary object of the invention is to ease the stress and uncertainty for children in families going through separation and divorce. The bag and journal are intended to assist communication in families through the transition.

An advantage of the present invention is that it provides comfort for a child from a broken family.

Another advantage of the present invention is that both parents of the child may refer to the parenting guidelines to have a common parenting plan.

One more advantage of the present invention is that the calendar allows the child to know what his or her schedule is going to be, thereby providing continuity it their life.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of a front side of the transition journal of the present invention with a photo of the child and a front side of the transition bag of the present invention with a memorable photo from one side of the broken family removably attached;

FIG. 2 is a perspective view of a back side of the transition journal of the present invention with a photo of the child and back side of the transition bag of the present invention with a memorable photo from the other side of the broken family removably attached;

FIG. 3 is a perspective view of a front section of pages of the transition journal related to one side of the broken family, the section of pages including a contact page, calendar page, holiday schedule page, journal pages to write on, and psychologically instructive information on what needs to be communicated and the ground rules for the parenting notebook;

FIG. 4 is a perspective view of a back section of pages of the transition journal related to the other side of the broken family, the section of pages including a contact page, calendar page, holiday schedule page, journal pages to write on, and psychologically instructive information on what needs to be communicated and the ground rules for the parenting notebook.

### DETAILED DESCRIPTION OF THE INVENTION

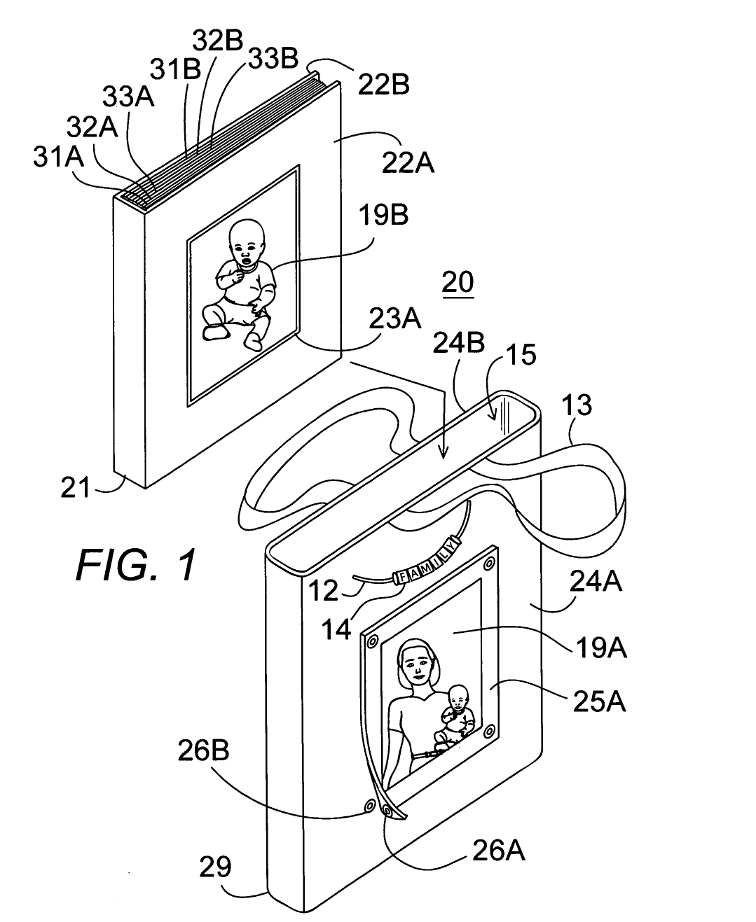

In FIGS. 1-4, a personal combination transition guide book journal and transition bag parent and child guidance system 20 for a child going through a psychological transition in a family divorce or separation. The system 20 comprises in combination a transition bag 29 and a transition journal 21 carried in the transition bag 29.

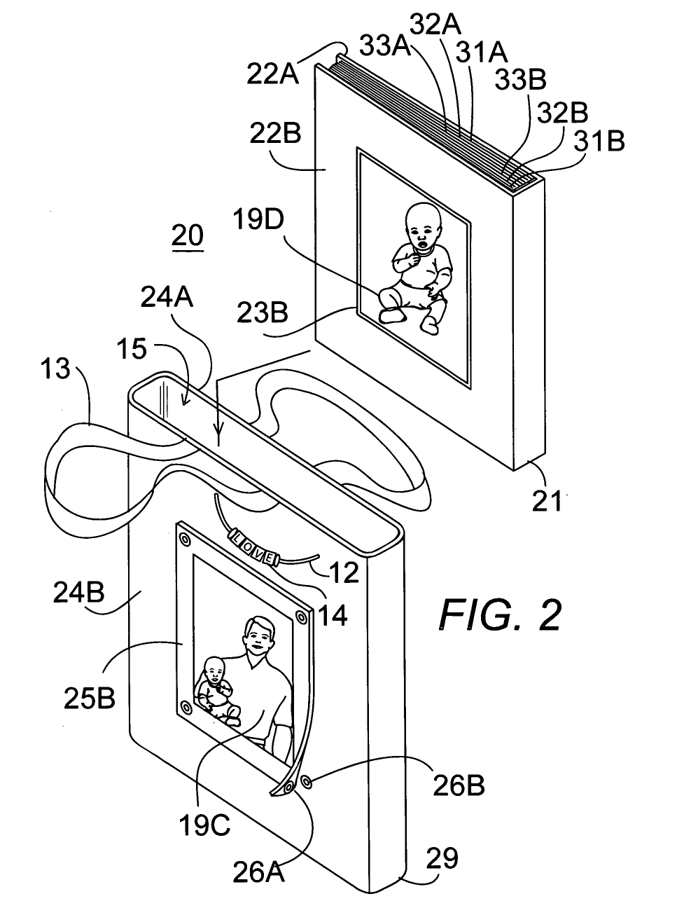

The transition bag 29 is provided for the child to carry memorabilia and family photos from both sides of the family associated with two separate family groups created by a family break up. The transition bag 29 comprises a washable transition carrying bag 29 having a first detachable decorative photo sleeve 25A on a front side 24A of the bag 29 to receive a memorable photograph 19A associated with a first broken family group, as shown in FIG. 1. The washable transition carrying bag 29 further comprises a second detachable decorative photo sleeve 25B on a back side 24B of the bag 29 to receive a memorable photograph 19B associated with a second broken family group, as shown in FIG. 2. The first and second detachable decorative photo sleeves 25A and 25B are removably connected to the bag 29 by a detachable connector 26A and 26B to remove the photo sleeves 25A and 25B for washing or cleaning the transition bag 29. The decorative photo sleeves 25A and 25B on the transition bag 29 each comprise a photo pocket 25A and 25B with peripheral snap connector elements 26A snapped onto mating snap connector elements 26B on one side of the transition bag 29, as in FIGS. 1 and 2. The photo pockets 25A and 25B may comprise any of a variety of photo pockets in a choice of colors.

The combination system 20 further comprises a string 12 of beads 14 with letters attached to each side of the bag 29 with comforting words spelled out on the beads 14, such as “family” and “love”, as shown in FIGS. 1 and 2 respectively.

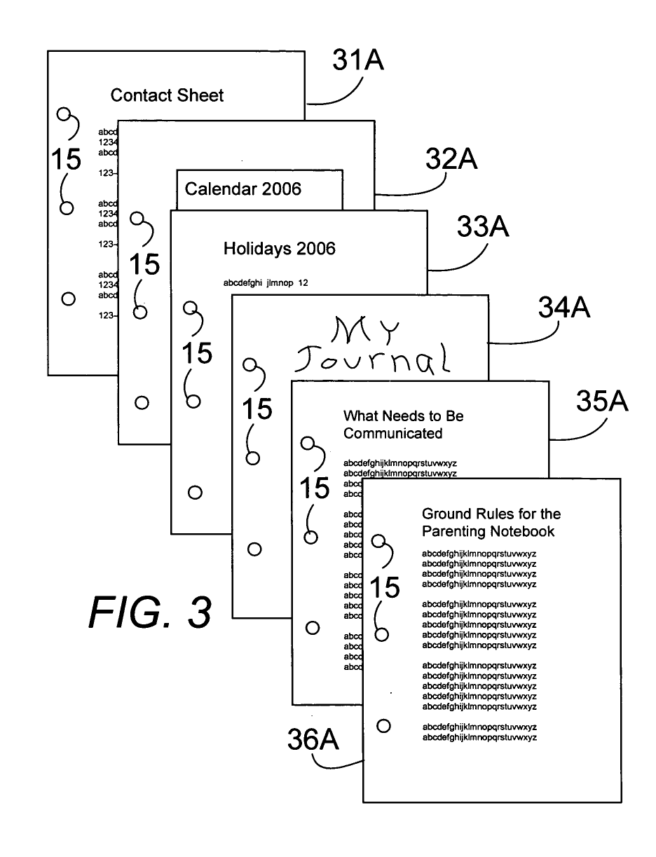

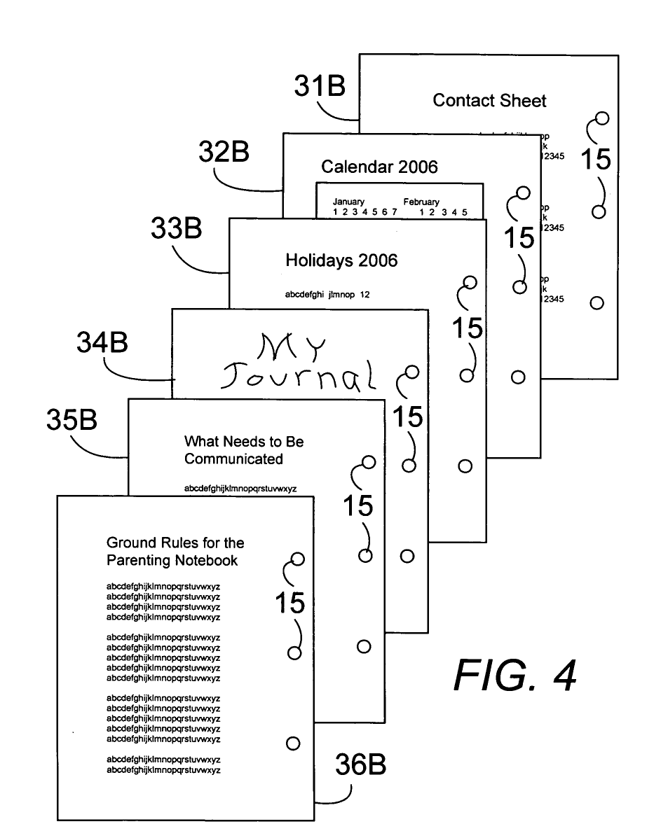

The transition journal 21 is carried in the transition bag 29, as indicated by the arrows in FIGS. 1 and 2. The journal 21 comprises a dual sided loose-leaf binder having a first photo sleeve 23A on a front cover 22A of the transition journal 21 for holding a photo 19A of the child, as shown in FIG. 1. The journal 21 also comprises a second photo sleeve 23B on a back cover 22B of the transition journal 21 for holding a photo 19B of the child, as shown in FIG. 2. The journal 21 further comprises a first series of pages 31A, 32A, 33A, 34A, 35A, and 36A, shown in FIG. 3, following the front cover 22A; and a second series of pages 31B, 32B, 33B, 34B, 35B, and 36B, shown in FIG. 4, following the back cover 22B. Each of the series of pages 31A-36A and 31B-36B comprises a personal contact sheet 31A and 31B for contacting the respective members of each side of the broken family, a calendar 32A and 32B for scheduling events with the respective members of each side of the broken family, a holiday list 33A and 33B associated with holiday events associated with the respective members of each side of the broken family, journal pages 34A and 34B for the parents to write relevant thoughts and feelings about the respective side of the broken family, information pages 35A and 35B on what needs to be communicated in a broken family and parenting ground rules 36A and 36B for behavior to assist a child in coping with a broken family.

The combination system 20 comprises a personalized way for the child to work through the difficult time of separation and divorce in a family and to compile photos 19A and 19B and other memorabilia all together in one place 20 to help the child work through their emotional difficulties and to assist communication in the broken family through the transition of separation and divorce.

In use, the child may carry the bag 29 and journal 21 between the two parent's homes. The bag 29 may carry not only the journal 29, but also favorite toys or special items to comfort the child during the time split between the parent's homes. The memorable pictures 19A and 19B of both sides of the family on the transition bag 29 allow the child to have a continued sense of continuity during the disruption of divorce, and further comfort the child when they may miss either one of the parents. The photographs 19A and 19B are preferably photos of the child with members of both sides of the broken family. The journal pages 35A and 35B allow parents to write down and express their feelings. The contact pages 31A and 31B, calendar pages 32A and 32B, and holiday scheduling pages 33A and 33B allow the parents to outline the child's schedule and further allow the child to have knowledge and certainty of what events are going to occur, thereby providing the much needed structure a child requires during a divorce. Both parents of the child may refer to the information pages on what needs to be communicated 36A and 36B in a broken family and pages on parenting ground rules 37A and 37B for behavior to assist the child in coping with a broken family and to form a common parenting plan.

The carrying bag 29 is preferably red, so that it may be easily be found by the child at all times. Alternately, the bag 29 may be the child's favorite color or may have the child's favorite designs (not shown) thereon to provide further comfort. The handles 13 of the bag 29 may also be marked with designs (not shown) or comforting words (not shown).

It is understood that the preceding description is given merely by way of illustration and not in limitation of the invention and that various modifications may be made thereto without departing from the spirit of the invention as claimed.

What is claimed is:

1. A personal combination transition guide book journal and transition bag self-help guidance system for a child going through a psychological transition in a family divorce or separation, the system comprising in combination:
a transition bag for carrying memorabilia and psychological transition self-help materials associated with two separate family groups created by a family break up, the transition bag comprising a washable transition carrying bag having a first detachable decorative photo sleeve on a front side of the bag to receive a memorable photograph associated with a first broken family group and a second detachable decorative photo sleeve on a back side of the bag to receive a memorable photograph associated with a second broken family group, the first and second detachable decorative photo sleeves removably connected to the bag by a detachable connector to remove the photo sleeves for washing or cleaning the transition bag;
a transition journal carried in the transition bag, the journal comprising a dual sided loose-leaf binder having a first photo sleeve on a front cover of the transition journal for holding a photo and a second photo sleeve on a back cover of the transition journal for holding another photo; a first series of pages following the front cover and a second series of pages following the back cover, each of the series of pages comprising a personal contact sheet for contacting the respective members of each side of the broken family, a calendar for scheduling events with the respective members of each side of the broken family, a holiday list associated with holiday events associated with the respective members of each side of the broken family, journal pages for the parents to write relevant thoughts and feelings, information pages on what needs to be communicated in a broken family and parenting ground rules for behavior to assist a child in coping with a broken family;
the combination system comprising a personalized way for the child to work through the difficult time of separation and divorce in a family and to compile photos and other memorabilia all together in one place to help the child work through the difficulties and to assist communication in the broken family through the transition of separation and divorce.

2. The combination system of claim 1 further comprising a string of beads with letters attached to each side of the bag with comforting words spelled out on the beads.

3. The combination system of claim 1 wherein the decorative photo sleeves on the transition bag each comprise a photo pocket with peripheral snap connector elements snapped onto mating snap connector elements on one side of the transition bag.

4. The combination system of claim 3 wherein the photo pockets comprise any of a variety of photo pockets in a choice of colors.
